(19) United States
(12) Patent Application Publication
(10) Pub. No.: US 2007/0039194 A1
(43) Pub. Date: Feb. 22, 2007

(54) Deburrer

(75) Inventor: Shmuel Dvir, Kfar Vradim (IL)

Correspondence Address: AKERMAN SENTERFITT, P.O. BOX 3188, WEST PALM BEACH, FL, 33402-3188, US

(73) Assignee: Vargus Ltd., Nathariya (IL)

(21) Appl. No.: 10/548,148

(22) PCT Filed: Oct. 31, 2003
(86) PCT No.: PCT/IB03/04931

§ 371 Date: Aug. 18, 2006

(30) Foreign Application Priority Data
Mar. 6, 2003 (DE) 203 04 002.3

(51) Int. Cl. B26B 3/00

(52) U.S. Cl. 30/317; 30/169

(57) ABSTRACT

A deburrer comprises a deburrer blade (19) accommodated in a tool-holder (16) which is, in turn, accommodated in a handle (12). The tool-holder (16) has a connection profile of the type of a screwdriver bit and can be plugged into the handle (12) or handle shaft (13). The deburrer blade (19) can be rotated in the bit and optionally exchanged and may have a crank-like design, for example. It is also possible to use deburrer blades made of a ceramic material and held in the bit.

### FIELD OF APPLICATION AND PRIOR ART

The invention relates to a deburrer with a deburrer blade having at least one deburrer cutting edge and which is received in a tool holder, which is in turn received in a handle.

Such deburrers are e.g. known from U.S. Pat. No. 3,787,972. A tool holder is received in length-adjustable manner by means of a locking mechanism in a handle. The tool holder has two receptacles for a deburrer blade constructed in crank-like manner and whereof one is axially directed and the other radially directed. They cross in such a way that both are secured against removal by a snap closure ball, but can be rotated. Such deburrers have long been used in a successful manner.

### PROBLEM AND SOLUTION

The problem of the invention is to provide a deburrer, which can be used even more universally and also in conjunction with other tools.

According to the invention this problem is solved in that the tool holder has a screwdriver connection profile in the manner of a bit.

Thus, instead of a long tool holder, a relatively short tool holder is created which can be inserted in a normal screwdriver with a bit connection. It can be held there by magnetic force or clamping. In place of a separate deburrer tool it is consequently possible to carry out deburring by simply inserting a bit in a screwdriver.

The deburrer blade can be replaceably received in the tool holder. It can be of the rotary type, in the manner shown and described in detail in U.S. Pat. No. 3,787,972, to which reference is made here. Retention by means of a snap closure and the possible arrangement with an axial or radial rotation axis can be implemented in the manner described in U.S. Pat. No. 3,787,972.

However, other deburrer blades can also be used, e.g. a blade which looks much like a knife blade, but which has a substantially isosceles triangular profile. This blade is inserted in fixed manner in the tool holder, but could also be inserted in such a way that the blade could be replaced.

However, in this case the blade is preferably fixed by screwing or pressing. This can also be provided in the case of a crank-like deburrer blade.

The connection profile is preferably a hexagonal profile matching commercial screwdriver bit receptacle.

These and other features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Embodiments of the invention are described hereinafter relative to the drawings, wherein show:

FIGS. 1 & 2 Part sectional side views of a deburrer and a larger scale detail thereof.

FIGS. 3 & 4 Representations corresponding to FIGS. 1 and 2 of a variant.

FIGS. 5 to 7 A further variant in a corresponding representation.

### DESCRIPTION OF AN EMBODIMENT

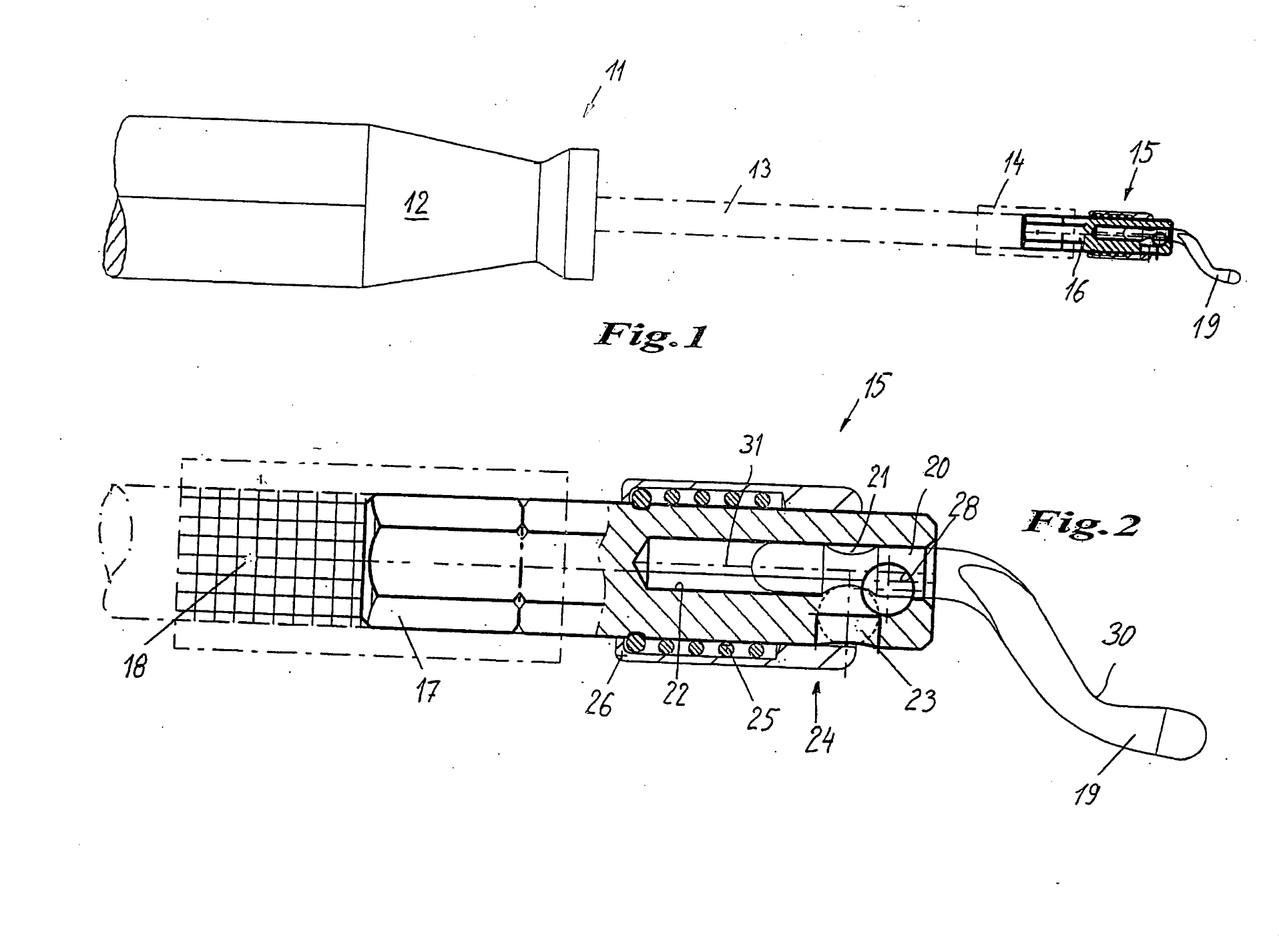

FIG. 1 shows a screwdriver 11 with a handle 12 and an associated shaft 13, on whose outer end is provided a receptacle 14 for a tool-carrying bit. In said receptacle is inserted a deburrer 15 having a tool holder 16. The tool holder has a hexagonal connection profile 17, which can be inserted in a corresponding hexagonal recess profile of the receptacle 14. The tool holder in the form of a bit is held therein by retention means, but can be released by pulling away. In the embodiment the retention means comprise a magnet 18, which is connected to the bottom of the hexagonal receptacle 14 and which cooperates with a tool holder made from ferromagnetic material, e.g. steel.

A deburrer blade 19 is received in the tool holder. In the construction according to FIGS. 1 to 4 it has a crank-like construction, i.e. it is S-shaped. On one side it has a substantially straight reception section 20, in which is located a flat rounded, circumferential groove 21. In the manner shown in FIG. 2, said reception section 20 is inserted and rotatable in an axially and somewhat eccentrically displaced bore 22 in the tool holder. The deburrer blade is axially secured in the seating bore 22, in that a ball 23 belonging to a snap closure 24 engages in the groove 21 as a blocking member. The ball is guided in a recess 25 of the tool holder 16 and is held therein in the position engaging in the groove 21 by a sleeve 26, which is loaded counter to the tension of a spring 27 in the direction of the tool-side end of the tool holder. The sleeve holds the ball in a blocking position. If, however, the sleeve 26 is moved manually in the axial direction away from the deburrer, the ball is freed to such an extent that it comes free from the groove 21 and can release the deburrer blade 19. The ball is secured against dropping out.

In the tool holder is provided a second seating bore 28, which is positioned radially instead of axially, but which is also displaced with respect to the longitudinal axis of the tool holder. The deburrer blade can be inserted in rotary, axially secured manner therein and is axially secured or released with respect to the deburrer blade by the same ball 23. Thus, the snap closure 24 is also effective for the transverse arrangement of the deburrer blade.

The deburrer functions as follows. The deburrer bit can be received in or on the handle 12 in a conventional manner or can be kept ready in some other way. For this purpose frequently receptacles for the connection profiles 17 are shaped into the screwdriver handles and in them in all-round manner can be inserted numerous bits in the vicinity of the shaft transition 29. The deburrer is removed therefrom and inserted in the receptacle 14, where it is held by the magnet 18 in such a way that working therewith is possible without having to fear it dropping out.

The deburrer blade is then moved along an edge, e.g. a sheet metal edge to be deburred in such a way that its deburrer cutting edge 30, which is located in the form of a concave channel in a bend of the S-shaped deburrer blade, can pass along the burr. As a result of the crank shape and the axial displacement between the rotation axis 31 of the deburrer blade and the cutting edge or its application point to the workpiece, together with the deburrer movement along the burr, a suitable cutting angle is automatically set between the cutting edge 30 and the workpiece.

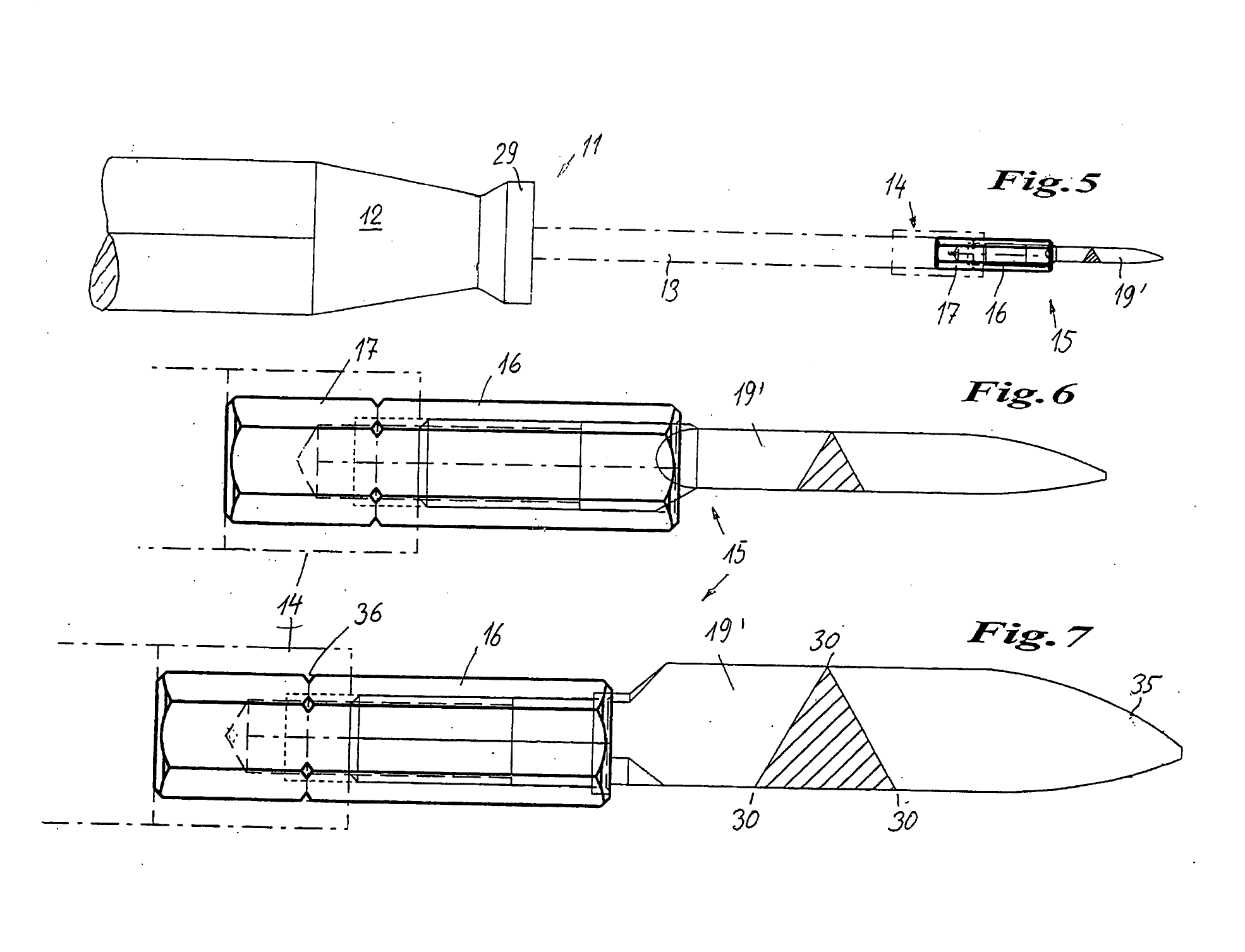

The deburrer blade can be made from a suitable tool steel, but also from hard metal or can be provided with a hard metal coating or facing. On becoming worn replacement thereof is possible in the tool holder, or alternatively it can be replaced by a different type of blade, e.g. for inside deburring or the like, in accordance with FIG. 5 of U.S. Pat. No. 3,787,972.

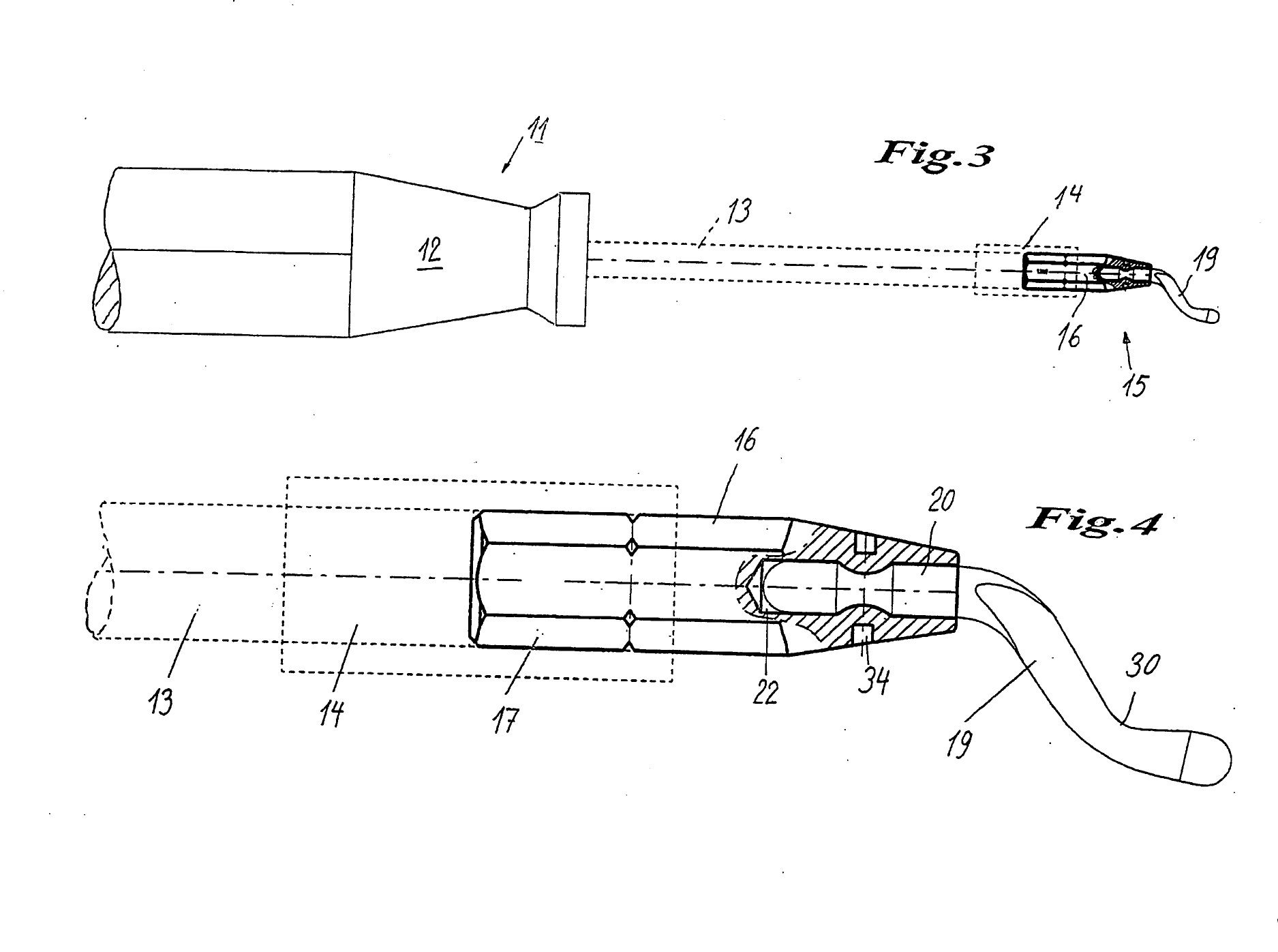

The construction according to FIGS. 3 and 4 shows a deburrer 15, which can be inserted in the same screwdriver 11 as in FIGS. 1 and 2. With regards to its connection profile and the deburrer blade, the deburrer is the same as in FIGS. 1 and 2, but in place of the snap closure 24 there is a permanent reception of the blade 19 in the tool holder 16. For this purpose the reception section 20 is inserted in a central bore on the free front face 33 of the tool holder and through two lateral impressions 35 material is shaped into the groove 21, so that at least in the axial direction the deburrer blade 19 is permanently fixed in the tool holder. This retention can be rotary or connected to rotate in accordance with the degree of said impression and the fit of section 20 in bore 22.

In this case the function is the same as described hereinbefore relative to FIGS. 1 and 2, but the deburrer can only be used in the longitudinal direction and not in the transverse direction, as would be the case in FIG. 1 and as described in U.S. Pat. No. 3,787,972. There is also no replacement of the deburrer blade, which is appropriate in view of the relatively small tool holder and the relatively long service life of the deburrer blade.

In the case of the invention the tool holder is relatively short and at a maximum has a length of five times the diameter of the connection profile 17 and is preferably only between three and four times said size. This saves material and also improves the handling of the deburrer, reducing tilting forces on the bit connection.

FIGS. 5 to 7 show a construction in which, for the same construction of the screwdriver and the connection profile 17 of the tool holder 16, a deburrer blade 19′ is inserted in fixed form therein. This can take place by plugging, screwing and/or pressing into a tool holder opening. The deburrer blade 19′ is in the form of a knife or scraper with a rounded, tapering tip 35. In the present case it has an isosceles triangular cross-section, so that in all there are three deburrer cutting edges 30, which consequently triple the deburrer service life. The triangular cross-section is shown in FIGS. 5 to 7 in the vicinity of the blade.

It is possible to see two different deburrer blade sizes, but which in both cases have the same bit connection. These blades should be made from a very wear-resistant, hard material, e.g. hard metal or a corresponding ceramic, such as is frequently used for special knives.

It is also possible to see a notch 36 in the vicinity of the connection profile and which in each case cuts the edges of the hexagon. It is provided in the case of screwdrivers to serve as a retaining means, which is constructed with another retaining mechanism as the magnet holder, e.g. by a retaining spring cooperating with said notches.

Said deburrer is used in the manner of a triangular scraper, in that it is manually moved along the object to be deburred.

It is clear that a deburrer is provided, which can be used in a very universal manner, employing commercial screwdrivers or corresponding tool receptacles. This is an important advantage, particularly for fitters and workmen working outside, because it is now possible using the always carried out screwdriver to have a deburrer which scarcely takes up any space in a tool case. As the deburrer holder length can vary considerably (e.g. 20 to 150 mm) the reachability range of the working location is very considerable.

Besides the hexagonal connection described, use can also be made of other connection profiles, which are well known and standardized. It is also possible to have a reversal (negative instead of positive receptacle or vice versa). The tool holder can easily be manufactured at limited cost from hexagonal rod stock having ferromagnetic properties, e.g. steel, but manufacture from plastics is also possible.

1. A deburrer with a deburrer blade having at least one deburrer cutting edge and received in a tool holder, which is in turn to be received in a handle, wherein the tool holder has a screwdriver connection profile in the manner of a bit.

2. The deburrer according to claim 1, wherein the deburrer blade is at least axially fixed in the tool holder.

3. The deburrer according to claim 1, wherein the deburrer blade is replaceably received in the tool holder.

4. The deburrer according to claim 1, wherein the deburrer blade is received in a rotary manner in the tool holder.

5. The deburrer according to claim 1, wherein the tool holder has an axial and a radial receptacle for the deburrer blade.

6. The deburrer according to claim 1, wherein the deburrer blade is received by means of a snap closure in the tool holder and which preferably contains a ball engaging in a circumferential groove of the deburrer blade and which is located in a wall recess of the tool holder and, under the action of a manually movable sleeve, can assume a blocking position and a release position for the axial fixing or removal of the deburrer blade.

7. The deburrer according to claim 1, wherein the deburrer blade has a crank-like shape.

8. The deburrer according to claim 1, wherein the deburrer blade has three cutting edges.

9. The deburrer according to claim 1, wherein the deburrer blade is made from or faced with a hard material.

10. The deburrer according to claim 1, wherein the connection profile is a hexagonal profile matching commercial screwdriver bit receptacles.

11. The deburrer according to claim 1, further comprising retention means for the tool holder in the receptacle of the handle or its shaft.

12. The deburrer according to claim 1, wherein the axial length of the tool holder is no more than five times the dimensions of the connection profile in the diameter direction or is between 20 mm and 150 mm.

13. The deburrer according to claim 7, wherein the deburrer blade has a concave deburrer cutting edge on an inner bend.

14. The deburrer according to claim 8, wherein the deburrer blade has three cutting edges in the form of an isosceles triangle.

15. The deburrer according to claim 9, wherein the deburrer blade is made from or faced with a hard metal or ceramic.

16. The deburrer according to claim 11, wherein the retention means comprise clamping or magnetic retention means.

17. The deburrer according to claim 11, wherein the tool holder contains ferromagnetic material for cooperating with a magnetic retention means.

18. The deburrer according to claim 12, wherein the axial length of the tool holder is between three and four times the dimensions of the connection profile in the diameter direction.
